(19) United States
(12) Patent Application Publication
(10) Pub. No.: US 2026/0200354 A1
(43) Pub. Date: Jul. 16, 2026

(54) ELECTRICAL SYSTEM AND RELATED SKID

(71) Applicant: 9479-9194 Québec inc., Drummondville (CA)

(72) Inventor: Ben KILLEN, Drummondville (CA)

(21) Appl. No.: 19/136,595

(22) PCT Filed: Dec. 11, 2023
(86) PCT No.: PCT/CA2023/051636

§ 371 Date: Jun. 6, 2025

Related U.S. Application Data
(60) Provisional application No. 63/386,720, filed on Dec. 9, 2022.

(51) Int. Cl. B60L 53/31; B60L 53/53; H02B 1/20; H02B 1/30; H02J 1/02; H02J 1/082; H02J 9/06

(52) U.S. Cl. CPC B60L 53/31; B60L 53/53; H02B 1/20; H02B 1/305; H02J 1/02; H02J 1/082; H02J 9/061

(57) ABSTRACT

An electrical system comprising a cabinet for receiving multi-phase lines, a multi-phase transformer having transformer taps to support power profiles and a distribution panel to provide phase-distinguished lines to 30 or more unit spaces. An actual output voltage is maintained between 408.0V and 456.7V from a specified 416V. Each unit space is configured to receive one or more 240V single pole breaker and one or more 480V to 600V multi-pole breaker. The electrical system may be used to provide power to electric vehicle chargers and is compatible with multiple variations of electric generation, transmission and distribution systems.

### TECHNICAL FIELD

The present invention relates to a modular electrical assembly and a related modular skid therefor.

### BACKGROUND

Electrical vehicle chargers are becoming widely necessary with the deployment of electrical vehicles. This is particularly true when fleets of electric vehicles are being deployed. Variations in the electric generation, transmission and distribution systems in different locations push for adoption of multiple solutions to the provision of power to electric vehicle chargers.

Solutions described herein aim at providing a modular skid and an electrical system that is compatible with multiple variations of electric generation, transmission and distribution systems. Skilled persons will readily understand that the resulting technical solutions are applicable to various industries.

### SUMMARY

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electrical system may include a plurality of electrical components comprising: a cabinet for receiving multi-phase lines; a multi-phase transformer having a plurality of transformer taps configured to support a plurality of power profiles from the multi-phase lines where an actual output voltage is maintained between 408.0V line-to-line and 456.7V line-to-line when a nominal secondary voltage of 416V line-to-line is specified; and a distribution panel configured to provide at least two phase-distinguished lines to 30 or more unit spaces, the unit spaces being configured to receive one or more 240V single pole breaker and one or more 480V to 600V multi-pole breaker.

Implementations may include one or more of the following features. The electrical system where the distribution panel comprises one or more busbar configured to provide a 120V auxiliary power system. The electrical system where the plurality of electrical components further comprises a battery energy storage system (BESS). The electrical system where the multi-phase transformer is a multi-phase K-rated transformer and the distribution panel is further configured to provide a harmonics-attenuation configuration having the K-rated transformer at least one of an enlarged neutral bus and enlarged phase lines. The electrical system where the cabinet is one of: a utility cabinet for receiving the multi-phase lines from an utility provider; and a main cabinet for receiving the multi-phase lines from one of an on-site power generator unit or a local power distribution system. The electrical system where the actual output voltage comprises at least two of:

| Utility | | Nominal | | Actual | Voltage | Voltage | | | Voltage | |
|---|---|---|---|---|---|---|---|---|---|---|
| Voltage | | Voltage | error | Voltage | Variation | Range | | Taps | Output Range | |
| 480 | V | 416 | −5% | 395.2 | 1% | 391.2 | 399.2 | 12.0% | 438.2 | 447.1 |
| 480 | V | 240 | −5% | 228.0 | 1% | 225.7 | 230.3 | 12.0% | 252.8 | 257.9 |
| 600 | V | 416 | −2% | 407.7 | 1% | 403.6 | 411.8 | 8.0% | 435.9 | 444.7 |
| 600 | V | 240 | −2% | 235.2 | 1% | 232.8 | 237.6 | 8.0% | 251.5 | 256.6 |
| 4.16 | kV | 416 | 0% | 416.0 | 1% | 411.8 | 420.2 | 5.0% | 432.4 | 441.2 |
| 4.16 | kV | 240 | 0% | 240.0 | 1% | 237.6 | 242.4 | 5.0% | 249.5 | 254.5 |
| 7.2 | kV | 416 | 2% | 424.3 | 1% | 420.1 | 428.6 | 3.0% | 432.7 | 441.4 |
| 7.2 | kV | 240 | 2% | 244.8 | 1% | 242.4 | 247.2 | 3.0% | 249.6 | 254.7 |
| 12.47 | kV | 416 | 5% | 436.8 | 1% | 432.4 | 441.2 | 0.0% | 432.4 | 441.2 |
| 12.47 | kV | 240 | 5% | 252.0 | 1% | 249.5 | 254.5 | 0.0% | 249.5 | 254.5 |
| 13.2 | kV | 416 | −5% | 395.2 | 3% | 383.3 | 407.1 | 13.0% | 433.2 | 460.0 |
| 13.2 | kV | 240 | −5% | 228.0 | 3% | 221.2 | 234.8 | 13.0% | 249.9 | 265.4 |
| 14.4 | kV | 416 | −2% | 407.7 | 3% | 395.4 | 419.9 | 10.0% | 435.0 | 461.9 |
| 14.4 | kV | 240 | −2% | 235.2 | 3% | 228.1 | 242.3 | 10.0% | 251.0 | 266.5 |
| 23.9 | kV | 416 | 0% | 416.0 | 3% | 403.5 | 428.5 | 7.5% | 433.8 | 460.6 |
| 23.9 | kV | 240 | 0% | 240.0 | 3% | 232.8 | 247.2 | 7.5% | 250.3 | 265.7 |
| 34.5 | kV | 416 | 2% | 424.3 | 3% | 411.6 | 437.0 | 5.0% | 432.2 | 458.9 |
| 34.5 | kV | 240 | 2% | 244.8 | 3% | 237.5 | 252.1 | 5.0% | 249.3 | 264.8 |
| 69 | kV | 416 | 5% | 436.8 | 3% | 423.7 | 449.9 | 2.5% | 434.3 | 461.2 |
| 69 | kV | 240 | 5% | 252.0 | 3% | 244.4 | 259.6 | 2.5% | 250.6 | 266.0 |
| 480 | V | 416 | −5% | 395.2 | 5% | 375.4 | 415.0 | 16.0% | 435.5 | 481.4 |
| 480 | V | 240 | −5% | 228.0 | 5% | 216.6 | 239.4 | 16.0% | 251.3 | 277.7 |
| 600 | V | 416 | −2% | 407.7 | 5% | 387.3 | 428.1 | 12.0% | 433.8 | 479.4 |
| 600 | V | 240 | −2% | 235.2 | 5% | 223.4 | 247.0 | 12.0% | 250.3 | 276.6 |
| 7.2 | kV | 416 | 0% | 416.0 | 5% | 395.2 | 436.8 | 10.0% | 434.7 | 480.5 |
| 7.2 | kV | 240 | 0% | 240.0 | 5% | 228.0 | 252.0 | 10.0% | 250.8 | 277.2 |
| 14.4 | kV | 416 | 2% | 424.3 | 5% | 403.1 | 445.5 | 8.0% | 435.4 | 481.2 |
| 14.4 | kV | 240 | 2% | 244.8 | 5% | 232.6 | 257.0 | 8.0% | 251.2 | 277.6 |
| 34.5 | kV | 416 | 5% | 436.8 | 5% | 415.0 | 458.6 | 5.0% | 435.7 | 481.6 |
| 34.5 | kV | 240 | 5% | 252.0 | 5% | 239.4 | 264.6 | 5.0% | 251.4 | 277.8 |
| 480 | V | 433 | −5% | 411.4 | 1% | 407.2 | 415.5 | 7.5% | 437.8 | 446.6 |
| 480 | V | 250 | −5% | 237.5 | 1% | 235.1 | 239.9 | 7.5% | 252.8 | 257.9 |
| 600 | V | 433 | −2% | 424.3 | 1% | 420.1 | 428.6 | 5.0% | 441.1 | 450.0 |
| 600 | V | 250 | −2% | 245.0 | 1% | 242.6 | 247.5 | 5.0% | 254.7 | 259.8 |
| 4.16 | kV | 433 | 0% | 433.0 | 1% | 428.7 | 437.3 | 2.5% | 439.4 | 448.3 |
| 4.16 | kV | 250 | 0% | 250.0 | 1% | 247.5 | 252.5 | 2.5% | 253.7 | 258.8 |
| 7.2 | kV | 433 | 2% | 441.7 | 1% | 437.2 | 446.1 | 0.0% | 437.2 | 446.1 |
| 7.2 | kV | 250 | 2% | 255.0 | 1% | 252.5 | 257.6 | 0.0% | 252.5 | 257.6 |
| 12.47 | kV | 433 | 5% | 454.7 | 1% | 450.1 | 459.2 | −2.5% | 438.9 | 447.7 |
| 12.47 | kV | 250 | 5% | 262.5 | 1% | 259.9 | 265.1 | −2.5% | 253.4 | 258.5 |
| 13.2 | kV | 433 | −5% | 411.4 | 3% | 399.0 | 423.7 | 8.5% | 432.9 | 459.7 |
| 13.2 | kV | 250 | −5% | 237.5 | 3% | 230.4 | 244.6 | 8.5% | 250.0 | 265.4 |
| 14.4 | kV | 433 | −2% | 424.3 | 3% | 411.6 | 437.1 | 5.0% | 432.2 | 458.9 |
| 14.4 | kV | 250 | −2% | 245.0 | 3% | 237.7 | 252.4 | 5.0% | 249.5 | 265.0 |
| 23.9 | kV | 433 | 0% | 433.0 | 3% | 420.0 | 446.0 | 3.0% | 432.6 | 459.4 |
| 23.9 | kV | 250 | 0% | 250.0 | 3% | 242.5 | 257.5 | 3.0% | 249.8 | 265.2 |
| 34.5 | kV | 433 | 2% | 441.7 | 3% | 428.4 | 454.9 | 1.0% | 432.7 | 459.5 |
| 34.5 | kV | 250 | 2% | 255.0 | 3% | 247.4 | 262.7 | 1.0% | 249.8 | 265.3 |
| 69 | kV | 433 | 5% | 454.7 | 3% | 441.0 | 468.3 | −2.0% | 432.2 | 458.9 |
| 69 | kV | 250 | 5% | 262.5 | 3% | 254.6 | 270.4 | −2.0% | 249.5 | 265.0 |
| 480 | V | 433 | −5% | 411.4 | 5% | 390.8 | 431.9 | 10.0% | 429.9 | 475.1 |
| 480 | V | 250 | −5% | 237.5 | 5% | 225.6 | 249.4 | 10.0% | 248.2 | 274.3 |
| 600 | V | 433 | −2% | 424.3 | 5% | 403.1 | 445.6 | 7.0% | 431.3 | 476.7 |
| 600 | V | 250 | −2% | 245.0 | 5% | 232.8 | 257.3 | 7.0% | 249.0 | 275.3 |
| 7.2 | kV | 433 | 0% | 433.0 | 5% | 411.4 | 454.7 | 5.0% | 431.9 | 477.4 |
| 7.2 | kV | 250 | 0% | 250.0 | 5% | 237.5 | 262.5 | 5.0% | 249.4 | 275.6 |
| 14.4 | kV | 433 | 2% | 441.7 | 5% | 419.6 | 463.7 | 3.0% | 432.2 | 477.7 |
| 14.4 | kV | 250 | 2% | 255.0 | 5% | 242.3 | 267.8 | 3.0% | 249.5 | 275.8 |
| 34.5 | kV | 433 | 5% | 454.7 | 5% | 431.9 | 477.4 | 0.0% | 431.9 | 477.4 |
| 34.5 | kV | 250 | 5% | 262.5 | 5% | 249.4 | 275.6 | 0.0% | 249.4 | 275.6 |

The electrical system may include a tap-switch between the transformer taps and the distribution panel on at least one of the multi-phase lines, the tap-switch being configured to be operated while power is being received. The electrical system may include a voltage regulator between the transformer taps and the distribution panel on at least one of the multi-phase lines. The electrical system may include an uninterruptible-power-supply (UPS) module between the transformer taps and the distribution panel on at least one of the multi-phase lines. The electrical system may include a control system configured to: monitor an actual voltage for a corresponding nominal transformer output on the at least one of the multi-phase lines; and operate, considering the capacities of the voltage regulator, the tap-switch for voltage-stabilization thereof, the UPS preventing a gap during operation of the tap-switch between transformers taps. The electrical system where the plurality of electrical components further comprises an external-power-source-input component for receiving power from one or more alternate power generation unit, the external-power-source-input component providing power received therefrom to the multi-tap transformer. The electrical system may include a cancelling harmonic filter connected to either the distribution panel or cabinet.

In one general aspect, a skid may include a plurality of openings defining: a first position configured to receive a cabinet; a second position configured to receive a power manipulation component; and a third position configured to receive a distribution panel. Skid may also include pre-positioned mechanical elements configured to structurally integrate two or more additional skids thereto, the additional skids when integrated providing at least a fourth position configured to receive one of the plurality of electrical components. Skid may furthermore include a walk-way of at least 3 feet of width having one or more detachably attachable floor panels. Skid may in addition include where the first position and the third position are positioned back-to-back and fit within 6 feet when the cabinet and the distribution panel are installed. Skid may moreover include where the skid is no more than 11.5 feet wide, 40 feet long and 12.5 feet high in order to fit within an expected parking lot spot.

Implementations may include one or more of the following features. The skid may include a longitudinal section, the plurality of openings being positioned therein, the longitudinal section being no more than 8 feet 6 inches. The skid where the walk-way extends on all of the longitudinal length of the skid. The skid where the floor panels provide anti-slippery walking surfaces. The skid may include inner lifting points positioned considering expected mechanical loads of the plurality of electrical components. Implementations of the described techniques may include hardware, a method or process, or a computer tangible medium.

### BRIEF DESCRIPTION OF THE DRAWINGS

Further features and exemplary advantages of the present invention will become apparent from the following detailed description, taken in conjunction with the appended drawings, in which:

FIGS. 1A, FIG. 1B and FIG. 1C herein referred to concurrently as FIG. 1 are logical circuit representations of exemplary systems in accordance with the teachings of the present invention;

FIGS. 2A, FIG. 2B, FIG. 2C, FIG. 2D, FIG. 2E, FIG. 2F and FIG. 2G herein referred to concurrently as FIG. 2 are views of an exemplary skid with electrical components in accordance with the teachings of the present invention; and

FIGS. 3A, FIG. 3B and FIG. 3C herein referred to concurrently as FIG. 3 are views of an exemplary skid without installed components in accordance with the teachings of the present invention.

### DETAILED DESCRIPTION

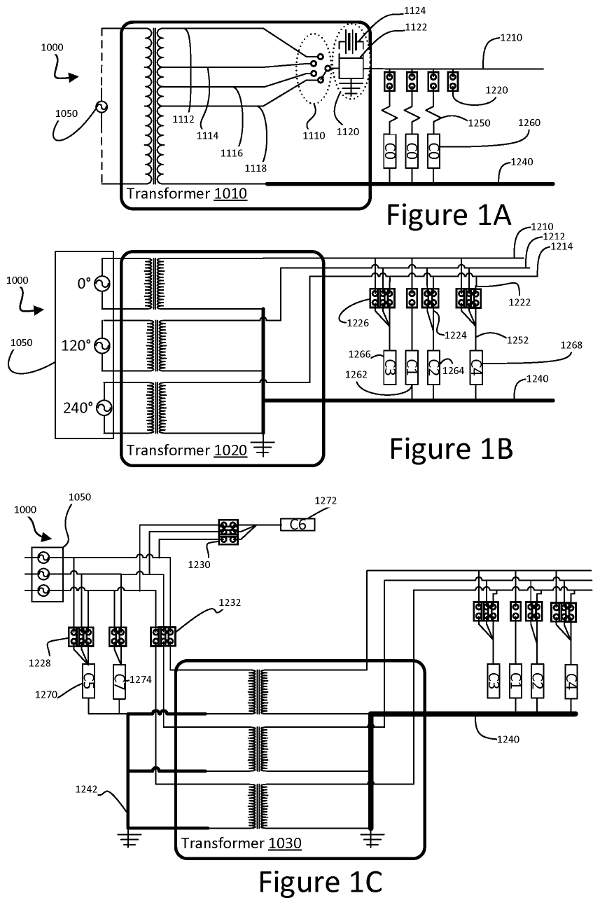

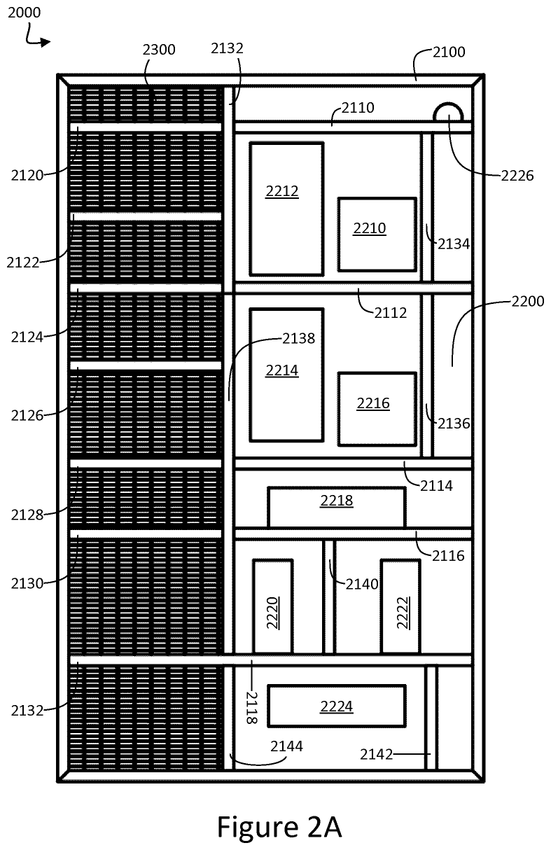

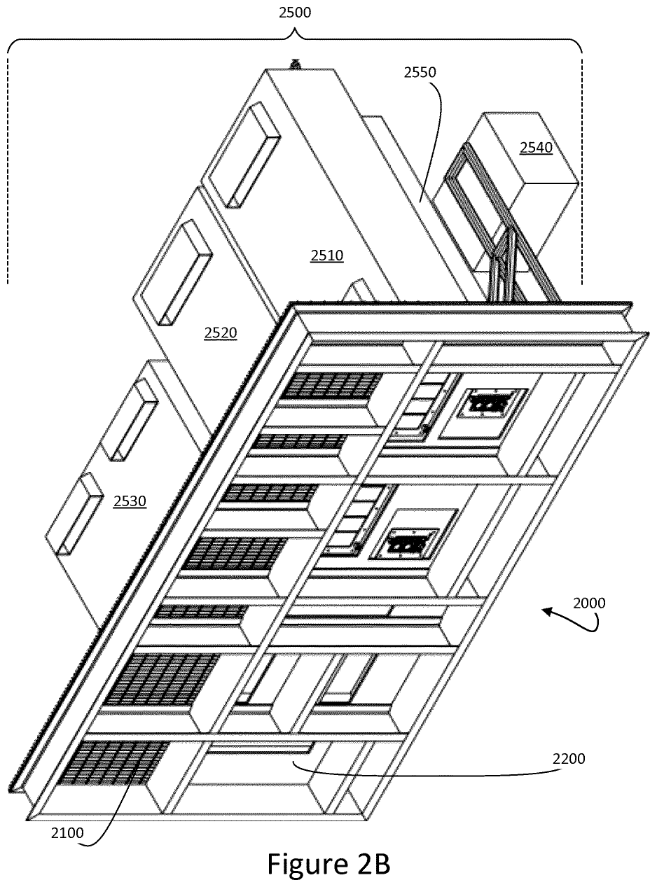

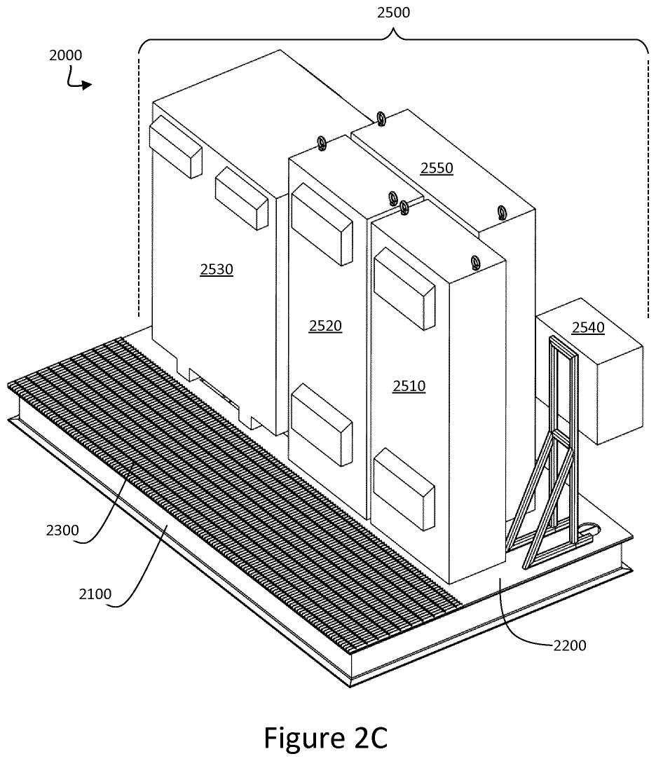

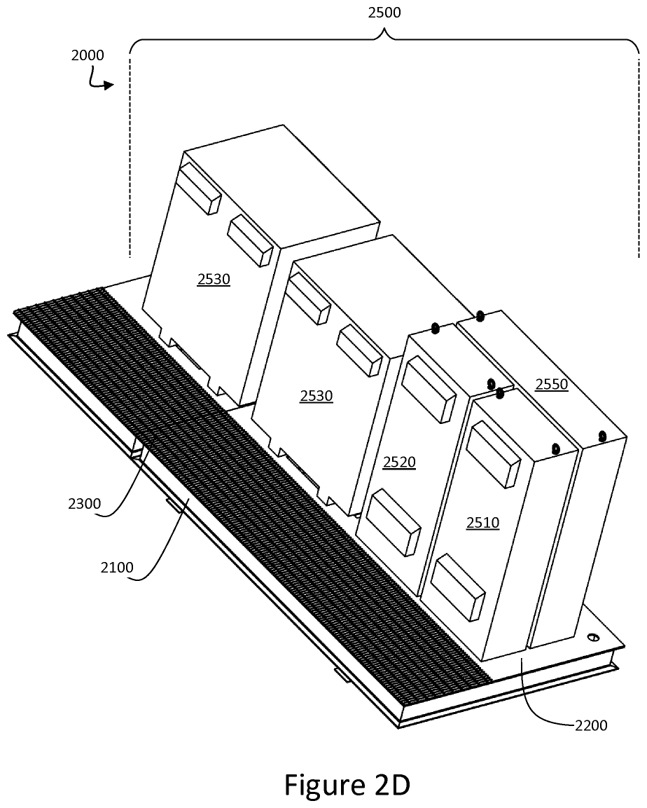

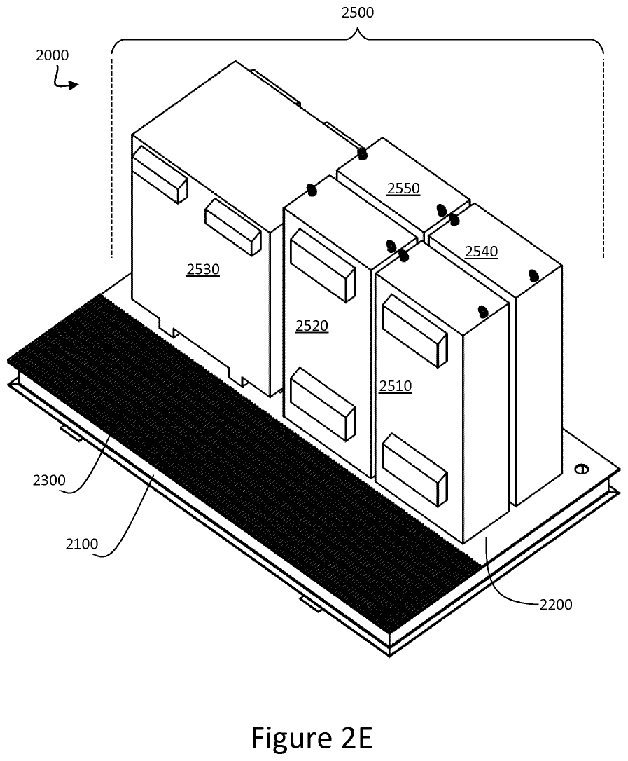

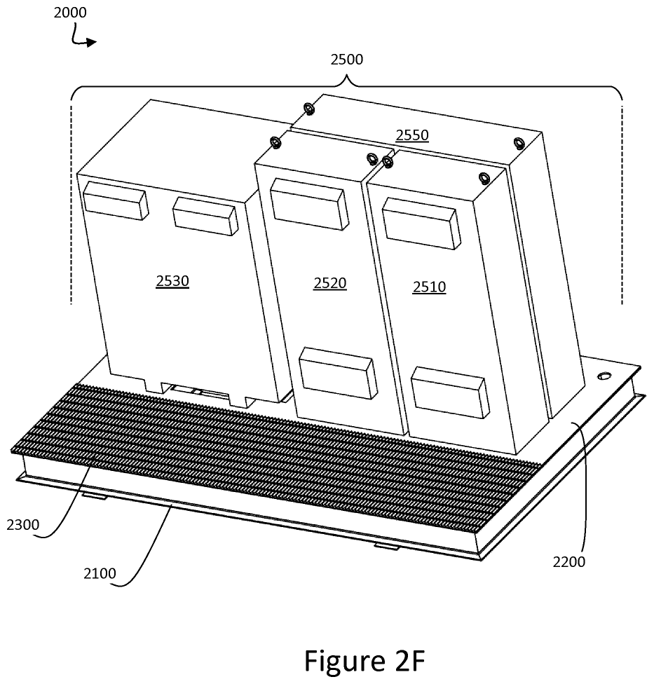

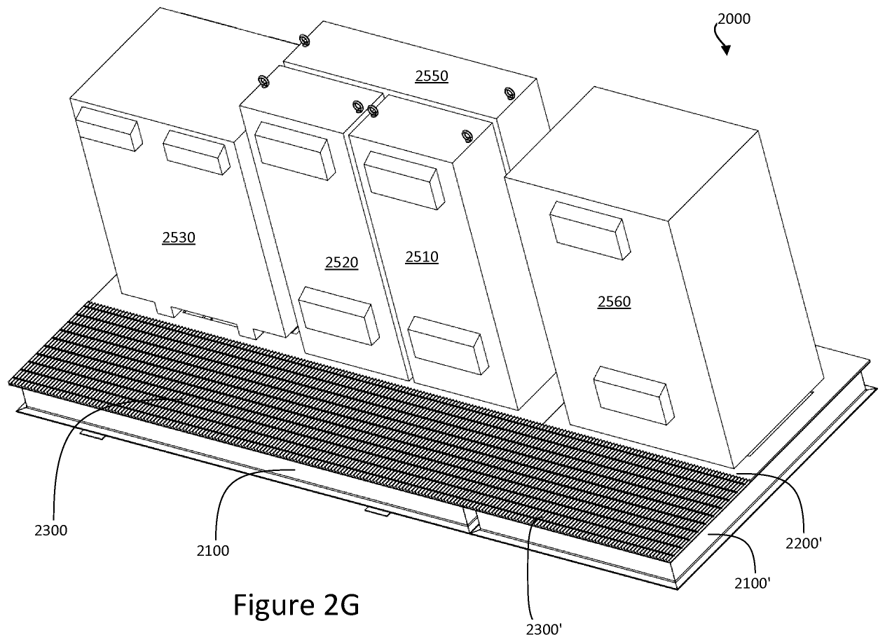

Reference is now made to the drawings in which FIG. 1 show examples of circuits and FIG. 2 shows examples of physical arrangement of the circuits on a modular skid.

On FIG. 1A, only one phase from a power source 1050 from a utility provider is depicted for simplicity of explanation of certain concepts. A K-rated multiphase transformer 1010 is shown with multiple taps 1112, 1114, 1116, 1118. In the depicted examples, the taps are connected to an optional multitap switch 1110, which may be operable when the transformer 1010 is under load to account for variation from the power source 1050. In other examples, the taps are directly connected. An optional assembly 1120 comprising a voltage regulator 1122 and uninterruptible power supply (UPS) 1124 is also depicted. The voltage regulator 1122 may also be provided without the UPS 1124. The UPS 1124 may be useful when the multitap switch 1110 is provided as there may be a brief disconnection upon operation of the multitap switch 1110. The voltage regulator may be useful in further stabilizing the difference in electric potential (e.g., 240V, 120V, . . . ) between the transformer 1010 outputs 1210 and 1240 considering variations from the power source 1050. Multiple circuit breakers 1220 are shown interconnecting a circuit 1250 between the outputs 1210 and 1240. The circuit 1250 comprises an EV charger 1260 C0. The circuit breaker 1220 could be 240V-rated one-pole breaker operating (e.g., single phase). The neutral output 1240 is shown as being supersized, which may be useful for harmonics attenuation. The outputs 1210, 1212 and 1214 may also alternatively or additionally be oversized for the same purpose of harmonics attenuation.

The illustrated example of K-rated multitap transformers 1020 and 1030 omit depiction of taps and also omit depiction of the optional multitap switch 1110 and the optional assembly 1120 for clarity of the drawings. When provided in the multitap transformer 1020 or 1030, the optional multitap switch 1110 may operate on all phases at once (e.g., synchronized multiphase switching) or may be operable to switch between taps on a subset of the phases, which may be helpful when the power source 1050 does not provide equivalent stability between the phases. FIG. 1B depicts different exemplary EV chargers 1262 C1 (similar to C0 1260), 1264 C2, 1266 C3 (3 phases no neutral) and 1268 C4 (3 phases and neutral) connected from the K-rated multitap transformer 1220. FIG. 1C further depicts additional exemplary EV chargers 1270 C5 (similar to C4 1268), 1274 C6 (similar to C3 1266) and 1274 C7 (similar to C4 1268). The additional exemplary EV chargers are shown connected before the K-rated multi-tap transformer 1030, which may be done when the power source 1050 is trusted to provide acceptable voltages. An additional 3-phase breaker 1232 would typically to be provided in such a scenario. Furthermore, a grounded input terminal line 1242 of the K-rated multitap transformer 1030 may be oversized for harmonics attenuation purposes.

Table 1 provides examples of acceptable ranges of voltage that EV chargers may accept. Table 2 provides examples of taps that may be provided in the K-rated multitap transformer considering the acceptable voltage of Table 1.

TABLE 1
Examples of nominal voltage operation
for EV chargers and acceptable ranges

| Nominal operation voltage | | |
|---|---|---|
| for an EV charger | Allowable Variation | Acceptable Ranges |
| 480 V | 10% | 432 V to 528 V |
| 416 V | 10% | 374.4 V to 457.6 V |
| 240 V | 10% | 216 V to 264 V |

TABLE 2
Examples of taps accounting for errors and variations
considering the EV chargers acceptable ranges

| Utility | | Nominal | | Actual | Voltage | Voltage | | | Voltage | |
|---|---|---|---|---|---|---|---|---|---|---|
| Voltage | | Voltage | error | Voltage | Variation | Range | | Taps | Output Range | |
| 480 | V | 416 | −5% | 395.2 | 1% | 391.2 | 399.2 | 12.0% | 438.2 | 447.1 |
| 480 | V | 240 | −5% | 228.0 | 1% | 225.7 | 230.3 | 12.0% | 252.8 | 257.9 |
| 600 | V | 416 | −2% | 407.7 | 1% | 403.6 | 411.8 | 8.0% | 435.9 | 444.7 |
| 600 | V | 240 | −2% | 235.2 | 1% | 232.8 | 237.6 | 8.0% | 251.5 | 256.6 |
| 4.16 | kV | 416 | 0% | 416.0 | 1% | 411.8 | 420.2 | 5.0% | 432.4 | 441.2 |
| 4.16 | kV | 240 | 0% | 240.0 | 1% | 237.6 | 242.4 | 5.0% | 249.5 | 254.5 |
| 7.2 | kV | 416 | 2% | 424.3 | 1% | 420.1 | 428.6 | 3.0% | 432.7 | 441.4 |
| 7.2 | kV | 240 | 2% | 244.8 | 1% | 242.4 | 247.2 | 3.0% | 249.6 | 254.7 |
| 12.47 | kV | 416 | 5% | 436.8 | 1% | 432.4 | 441.2 | 0.0% | 432.4 | 441.2 |
| 12.47 | kV | 240 | 5% | 252.0 | 1% | 249.5 | 254.5 | 0.0% | 249.5 | 254.5 |
| 13.2 | kV | 416 | −5% | 395.2 | 3% | 383.3 | 407.1 | 13.0% | 433.2 | 460.0 |
| 13.2 | kV | 240 | −5% | 228.0 | 3% | 221.2 | 234.8 | 13.0% | 249.9 | 265.4 |
| 14.4 | kV | 416 | −2% | 407.7 | 3% | 395.4 | 419.9 | 10.0% | 435.0 | 461.9 |
| 14.4 | kV | 240 | −2% | 235.2 | 3% | 228.1 | 242.3 | 10.0% | 251.0 | 266.5 |
| 23.9 | kV | 416 | 0% | 416.0 | 3% | 403.5 | 428.5 | 7.5% | 433.8 | 460.6 |
| 23.9 | kV | 240 | 0% | 240.0 | 3% | 232.8 | 247.2 | 7.5% | 250.3 | 265.7 |
| 34.5 | kV | 416 | 2% | 424.3 | 3% | 411.6 | 437.0 | 5.0% | 432.2 | 458.9 |
| 34.5 | kV | 240 | 2% | 244.8 | 3% | 237.5 | 252.1 | 5.0% | 249.3 | 264.8 |
| 69 | kV | 416 | 5% | 436.8 | 3% | 423.7 | 449.9 | 2.5% | 434.3 | 461.2 |
| 69 | kV | 240 | 5% | 252.0 | 3% | 244.4 | 259.6 | 2.5% | 250.6 | 266.0 |
| 480 | V | 416 | −5% | 395.2 | 5% | 375.4 | 415.0 | 16.0% | 435.5 | 481.4 |
| 480 | V | 240 | −5% | 228.0 | 5% | 216.6 | 239.4 | 16.0% | 251.3 | 277.7 |
| 600 | V | 416 | −2% | 407.7 | 5% | 387.3 | 428.1 | 12.0% | 433.8 | 479.4 |
| 600 | V | 240 | −2% | 235.2 | 5% | 223.4 | 247.0 | 12.0% | 250.3 | 276.6 |
| 7.2 | kV | 416 | 0% | 416.0 | 5% | 395.2 | 436.8 | 10.0% | 434.7 | 480.5 |
| 7.2 | kV | 240 | 0% | 240.0 | 5% | 228.0 | 252.0 | 10.0% | 250.8 | 277.2 |
| 14.4 | kV | 416 | 2% | 424.3 | 5% | 403.1 | 445.5 | 8.0% | 435.4 | 481.2 |
| 14.4 | kV | 240 | 2% | 244.8 | 5% | 232.6 | 257.0 | 8.0% | 251.2 | 277.6 |
| 34.5 | kV | 416 | 5% | 436.8 | 5% | 415.0 | 458.6 | 5.0% | 435.7 | 481.6 |
| 34.5 | kV | 240 | 5% | 252.0 | 5% | 239.4 | 264.6 | 5.0% | 251.4 | 277.8 |
| 480 | V | 433 | −5% | 411.4 | 1% | 407.2 | 415.5 | 7.5% | 437.8 | 446.6 |
| 480 | V | 250 | −5% | 237.5 | 1% | 235.1 | 239.9 | 7.5% | 252.8 | 257.9 |
| 600 | V | 433 | −2% | 424.3 | 1% | 420.1 | 428.6 | 5.0% | 441.1 | 450.0 |
| 600 | V | 250 | −2% | 245.0 | 1% | 242.6 | 247.5 | 5.0% | 254.7 | 259.8 |
| 4.16 | kV | 433 | 0% | 433.0 | 1% | 428.7 | 437.3 | 2.5% | 439.4 | 448.3 |
| 4.16 | kV | 250 | 0% | 250.0 | 1% | 247.5 | 252.5 | 2.5% | 253.7 | 258.8 |
| 7.2 | kV | 433 | 2% | 441.7 | 1% | 437.2 | 446.1 | 0.0% | 437.2 | 446.1 |
| 7.2 | kV | 250 | 2% | 255.0 | 1% | 252.5 | 257.6 | 0.0% | 252.5 | 257.6 |
| 12.47 | kV | 433 | 5% | 454.7 | 1% | 450.1 | 459.2 | −2.5% | 438.9 | 447.7 |
| 12.47 | kV | 250 | 5% | 262.5 | 1% | 259.9 | 265.1 | −2.5% | 253.4 | 258.5 |
| 13.2 | kV | 433 | −5% | 411.4 | 3% | 399.0 | 423.7 | 8.5% | 432.9 | 459.7 |
| 13.2 | kV | 250 | −5% | 237.5 | 3% | 230.4 | 244.6 | 8.5% | 250.0 | 265.4 |
| 14.4 | kV | 433 | −2% | 424.3 | 3% | 411.6 | 437.1 | 5.0% | 432.2 | 458.9 |
| 14.4 | kV | 250 | −2% | 245.0 | 3% | 237.7 | 252.4 | 5.0% | 249.5 | 265.0 |
| 23.9 | kV | 433 | 0% | 433.0 | 3% | 420.0 | 446.0 | 3.0% | 432.6 | 459.4 |
| 23.9 | kV | 250 | 0% | 250.0 | 3% | 242.5 | 257.5 | 3.0% | 249.8 | 265.2 |
| 34.5 | kV | 433 | 2% | 441.7 | 3% | 428.4 | 454.9 | 1.0% | 432.7 | 459.5 |
| 34.5 | kV | 250 | 2% | 255.0 | 3% | 247.4 | 262.7 | 1.0% | 249.8 | 265.3 |
| 69 | kV | 433 | 5% | 454.7 | 3% | 441.0 | 468.3 | −2.0% | 432.2 | 458.9 |
| 69 | kV | 250 | 5% | 262.5 | 3% | 254.6 | 270.4 | −2.0% | 249.5 | 265.0 |
| 480 | V | 433 | −5% | 411.4 | 5% | 390.8 | 431.9 | 10.0% | 429.9 | 475.1 |
| 480 | V | 250 | −5% | 237.5 | 5% | 225.6 | 249.4 | 10.0% | 248.2 | 274.3 |
| 600 | V | 433 | −2% | 424.3 | 5% | 403.1 | 445.6 | 7.0% | 431.3 | 476.7 |
| 600 | V | 250 | −2% | 245.0 | 5% | 232.8 | 257.3 | 7.0% | 249.0 | 275.3 |
| 7.2 | kV | 433 | 0% | 433.0 | 5% | 411.4 | 454.7 | 5.0% | 431.9 | 477.4 |
| 7.2 | kV | 250 | 0% | 250.0 | 5% | 237.5 | 262.5 | 5.0% | 249.4 | 275.6 |
| 14.4 | kV | 433 | 2% | 441.7 | 5% | 419.6 | 463.7 | 3.0% | 432.2 | 477.7 |
| 14.4 | kV | 250 | 2% | 255.0 | 5% | 242.3 | 267.8 | 3.0% | 249.5 | 275.8 |
| 34.5 | kV | 433 | 5% | 454.7 | 5% | 431.9 | 477.4 | 0.0% | 431.9 | 477.4 |
| 34.5 | kV | 250 | 5% | 262.5 | 5% | 249.4 | 275.6 | 0.0% | 249.4 | 275.6 |

For instance, in some implementations, the system allows for EV chargers operating at 240V (nominal) single phase, 415V (nominal) three phase, and 480V (nominal) three phase to connect and simultaneously operate on a common electrical panel and transformer by using a nominal system voltage of 416/240V and transformer taps sized to adjust the operating voltage to such a level where both the 240V and 480V chargers operate within their input voltage tolerances. The transformer taps may be sized to allow for maximum flexibility with the various EV charger input tolerances available on a given market while accounting for various utility voltage fluctuation specifications. The system may also be used in various markets and grid voltages and amperages by using a common electrical backbone that can be connected in different configurations with the appropriate modules connected (e.g., 480V breakers/transformers in the US and 600V in Canada, etc.). The backbone components may have a common skid footprint allowing for various combinations of components to be mounted on a single skid while meeting the requirements of each local utility provider and client requirements (e.g., number of electric vehicles, different power ratings of various EV chargers, site lighting requirements, and system communications). The common skid footprint may also allow for the system to be modular and expandable as not only can add-on components be upgraded, but so too can the backbone components. Furthermore, the backbone components can be provided with various harmonic ratings to boost the systems reliability, efficiency, and/or power quality. Versatility may be further extended through additional add-on (e.g., “plug in” and “bolt on”) components that allow for the connection of external power sources including but not limited to solar systems, wind turbines, battery backup systems (or battery energy storage system (BESS)), and generators. The add-on components may allow improved power quality (i.e., power factor correction capacitors, power management controllers, harmonic filters, etc.)

FIG. 2 depicts an exemplary modular skid 2000 comprising a frame 2100 on which a perforated steel plate 2200 and a grate 2300 (e.g., metal grate) are positioned. FIG. 2A show the skid 2000 from underneath while FIGS. 2B and 2C provide perspective views of the skid 2000 with an installed set of components 2500 thereon. The frame 2100 of the skid 2000 is dimensioned to fit within an expected parking lot spot.

The steel plate 2200 defines an openings configuration comprising openings 2210 to 2226. The frame 2100 further defines a members configuration comprising members 2110 to 2144. The frame 2100 and member configuration provide structural support for the skid 2000 while providing access to the openings 2210 to 2226. The members 2110 to 2144 comprise longitudinal members 2110 to 2118 and transverse members 2120 to 2144. Skilled persons will readily recognize that the depicted openings configuration and members configuration is provided to be versatile and support a plurality of configurations for the set of components 2500. Of course, different openings configurations each supporting multiple configurations of the set of components 2500 may be provided without departing from the teachings found herein. Likewise, the proportion between the grate 2300 and the steel plate 2200 may vary, e.g., depending on the set of components 2500, the number of skids deployed at a single premises, etc. Not shown on FIG. 2 is a guardrail or a fence, which may be installed into additional openings (not shown) in the steel plate 2200 and/or the grate 2300 to receive posts (not shown) therefor. The guardrail or fence may also alternatively or additionally be maintained on the skid using conventional or custom retaining mechanisms. The guardrail or fence may be used considering electrical and/or building codes requirements, e.g., when the skid 2000 is installed on additional ground supports (not shown) that elevate the skid 2000. A set of lifting lugs (not shown) may also be positioned on the frame 2100.

The set of components 2500 depicts one of many electrical component configurations supported by the skid 2000. The set of components 2500 comprises, in the depicted example, a multi-phase K-rated multi-tap transformer 2530, a utility cabinet 2550 (also referred to as a metering cabinet), a junction box 2540 and distribution panels 2510 and 2520. In some embodiments, the distribution panel 2510 and/or 2520 provides 30 or more unit spaces, preferably 48, configured to receive one or more 240V single pole breaker and one or more 480V to 600V multi-pole breaker. The number of unit spaces is limited to the height of the distribution panel 2510/2520. Position of the electrical components affects the skid 2000 center of gravity. In some implementations, multiple positions for the lifting lugs may be suggested on the frame 2100 considering a subset of variations in the set of components 2500 in order to obtain a predictable center of gravity (e.g., within a range around a specific location). Alternatively or additionally, the lifting lugs may have a default position and the center of gravity of the skid 2000 when loaded with a specific set of components 2500 may then be computed in consideration thereof.

The skid 2000 may have specific dimensions determined from, among other things, one or more construction codes and one or more transportation codes. For instance, the modular skid 2000 may be no more than 11.5 feet wide, 40 feet long and 15 feet high, which has been determined based on the dimensions typically made available for buses in a parking lot. Other considerations maybe taken into account in dimensioning the skid 2000 and the various elements thereof. For instance, the grate 2300 is intended to serve as a walkway for gaining access to the mounted components in the final configuration of the skid 2000. As such, a minimum width of 30 inches (e.g., US code) or 1 m (Canadian Code) is desirable. Being able to deliver the skid 2000 on the road without necessitating special measures is also a desired feature that may be accomplished by having the overall width of the skid 2000 not exceed the related transportation code limitations. That is, the skid 2000 may be made to be no more than 8.5 feet in width. Considering the walkway of 3 feet, in such a configuration and with these limitations, the steel plate 2200 would therefore be limited to 5.5 feet.

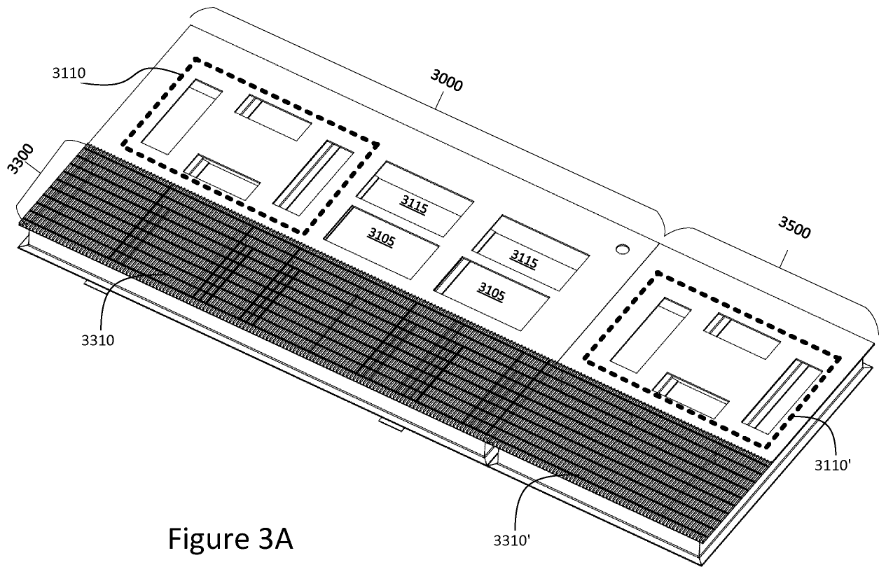

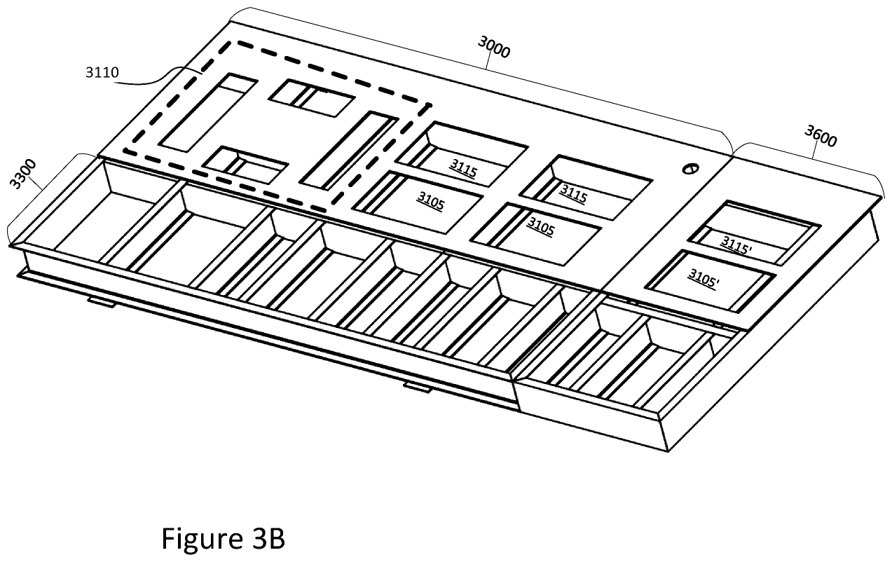

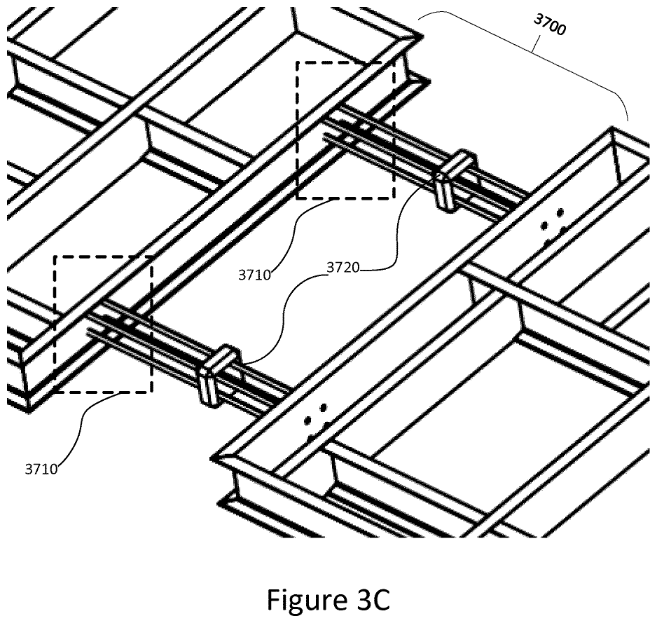

Depicted on FIG. 3 is a skid 3000 for supporting a plurality of electrical components. The skid 3000 comprising a plurality of openings. The plurality of openings defines multiple positions to receive electrical components that are accordingly dimensioned. For instance, the plurality of openings may define a first position 3105 configured to receive a cabinet (e.g., such as the utility cabinet 2550 as previously discussed), a second position 3110 configured to receive a power manipulation component (e.g., such as a transformer or a battery energy storage system (BESS)) and a third position 3115 configured to receive a distribution panel (e.g., such as the distribution panels 2510, 2520). As depicted on FIG. 3, more than one of the first, second and/or third positions 3105, 3110, 3115 may be provided on the skid 3000. The power manipulation component receives the raw, unconditioned electrical power from either the utility or other local power and completes the bulk of the manipulations to the properties of the power signal such that the output signal is one that fits within the operating parameters of the system. The power manipulation component may be further supplemented with additional power conditioning components such as a voltage regulator and/or tap changer to ensure the system remains within the operating parameters when significant fluctuations and/or disruptions are present in the unconditioned electrical power supply signal.

The skid 3000 also comprises pre-positioned mechanical elements 3700 configured to structurally integrate two or more additional skids 3500, 3600 thereto. The additional skids 3500, 3600 when integrated with the skid 3000 provides at least a fourth position 3105′, 3110′, 3115′ configured to receive one of the plurality of electrical components. The example of pre-positioned mechanical elements 3700 depicted on FIG. 3 comprise pre-drilled holes 3710 and, given the profile of the example of skids 3000, 3500, pre-drilled shim blocks 3720. Skilled persons will readily acknowledge that different variations on the density, number, and size of holes 3710 as well as configuration of the shim blocks 3720 may be designed without departing from the teachings provided herein. Likewise, other mechanical solutions may be devised to provide the function of the pre-positioned mechanical elements 3700.

The skid 3000 also comprises a walk-way 3300 of at least 3 feet of width having one or more detachably attachable floor panels 3310. The first position 3105 and the third 3115 position are positioned back-to-back and fit within 6 feet when the cabinet and the distribution panel are installed. The skid 3000 is no more than 11.5 feet wide, 40 feet long and 12.5 feet high in order to fit within an expected parking lot spot. Optionally, the skid 3000 may further comprise a longitudinal section, the plurality of openings being positioned therein, the longitudinal section being no more than 8 feet 6 inches. The walk-way 3300 may extend on all of the longitudinal length of the skid. The floor panels 3310 may provide anti-slippery walking surfaces. The skid 3000 may further comprise inner lifting points (e.g., loop bolts positioned on inner members and/or inner faces of external members) positioned considering expected mechanical loads of the plurality of electrical components. The positioning of the inner lifting points towards the inside of the skid 3000 may be done in order to remain within a target total width for the skid 3000

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

1. An electrical system comprising:
a plurality of electrical components comprising:
a cabinet for receiving multi-phase lines;
a multi-phase transformer comprising a plurality of transformer taps configured to support a plurality of power profiles from the multi-phase lines wherein an actual output voltage is maintained between 408.0V line-to-line and 456.7V line-to-line when a nominal secondary voltage of 416V line-to-line is specified; and
a distribution panel configured to provide at least two phase-distinguished lines to 30 or more unit spaces, the unit spaces being configured to receive one or more 240V single pole breaker and one or more 480V to 600V multi-pole breaker.

2. The system of claim 1 wherein the distribution panel comprises one or more busbar configured to provide a 120V auxiliary power system.

3. The system of claim 1, wherein the plurality of electrical components further comprises a battery energy storage system (BESS).

4. The system of claim 1, wherein the multi-phase transformer is a multi-phase K-rated transformer and the distribution panel is further configured to provide a harmonics-attenuation configuration comprising the K-rated transformer at least one of an enlarged neutral bus and enlarged phase lines.

5. The system of claim 1, wherein the cabinet is one of:
a utility cabinet for receiving the multi-phase lines from a utility provider; and
a main cabinet for receiving the multi-phase lines from one of an on-site power generator unit or a local power distribution system.

6. The system of claim 1, wherein the actual output voltage comprises at least two of:

| Input | | Nominal | | Actual | Voltage | Voltage | | | Voltage | |
|---|---|---|---|---|---|---|---|---|---|---|
| Voltage | | Voltage | error | Voltage | Variation | Range | | Taps | Output Range | |
| 480 | V | 416 | −5% | 395.2 | 1% | 391.2 | 399.2 | 12.0% | 438.2 | 447.1 |
| 480 | V | 240 | −5% | 228.0 | 1% | 225.7 | 230.3 | 12.0% | 252.8 | 257.9 |
| 600 | V | 416 | −2% | 407.7 | 1% | 403.6 | 411.8 | 8.0% | 435.9 | 444.7 |
| 600 | V | 240 | −2% | 235.2 | 1% | 232.8 | 237.6 | 8.0% | 251.5 | 256.6 |
| 4.16 | kV | 416 | 0% | 416.0 | 1% | 411.8 | 420.2 | 5.0% | 432.4 | 441.2 |
| 4.16 | kV | 240 | 0% | 240.0 | 1% | 237.6 | 242.4 | 5.0% | 249.5 | 254.5 |
| 7.2 | kV | 416 | 2% | 424.3 | 1% | 420.1 | 428.6 | 3.0% | 432.7 | 441.4 |
| 7.2 | kV | 240 | 2% | 244.8 | 1% | 242.4 | 247.2 | 3.0% | 249.6 | 254.7 |
| 12.47 | kV | 416 | 5% | 436.8 | 1% | 432.4 | 441.2 | 0.0% | 432.4 | 441.2 |
| 12.47 | kV | 240 | 5% | 252.0 | 1% | 249.5 | 254.5 | 0.0% | 249.5 | 254.5 |
| 13.2 | kV | 416 | −5% | 395.2 | 3% | 383.3 | 407.1 | 13.0% | 433.2 | 460.0 |
| 13.2 | kV | 240 | −5% | 228.0 | 3% | 221.2 | 234.8 | 13.0% | 249.9 | 265.4 |
| 14.4 | kV | 416 | −2% | 407.7 | 3% | 395.4 | 419.9 | 10.0% | 435.0 | 461.9 |
| 14.4 | kV | 240 | −2% | 235.2 | 3% | 228.1 | 242.3 | 10.0% | 251.0 | 266.5 |
| 23.9 | kV | 416 | 0% | 416.0 | 3% | 403.5 | 428.5 | 7.5% | 433.8 | 460.6 |
| 23.9 | kV | 240 | 0% | 240.0 | 3% | 232.8 | 247.2 | 7.5% | 250.3 | 265.7 |
| 34.5 | kV | 416 | 2% | 424.3 | 3% | 411.6 | 437.0 | 5.0% | 432.2 | 458.9 |
| 34.5 | kV | 240 | 2% | 244.8 | 3% | 237.5 | 252.1 | 5.0% | 249.3 | 264.8 |
| 69 | kV | 416 | 5% | 436.8 | 3% | 423.7 | 449.9 | 2.5% | 434.3 | 461.2 |
| 69 | kV | 240 | 5% | 252.0 | 3% | 244.4 | 259.6 | 2.5% | 250.6 | 266.0 |
| 480 | V | 416 | −5% | 395.2 | 5% | 375.4 | 415.0 | 16.0% | 435.5 | 481.4 |
| 480 | V | 240 | −5% | 228.0 | 5% | 216.6 | 239.4 | 16.0% | 251.3 | 277.7 |
| 600 | V | 416 | −2% | 407.7 | 5% | 387.3 | 428.1 | 12.0% | 433.8 | 479.4 |
| 600 | V | 240 | −2% | 235.2 | 5% | 223.4 | 247.0 | 12.0% | 250.3 | 276.6 |
| 7.2 | kV | 416 | 0% | 416.0 | 5% | 395.2 | 436.8 | 10.0% | 434.7 | 480.5 |
| 7.2 | kV | 240 | 0% | 240.0 | 5% | 228.0 | 252.0 | 10.0% | 250.8 | 277.2 |
| 14.4 | kV | 416 | 2% | 424.3 | 5% | 403.1 | 445.5 | 8.0% | 435.4 | 481.2 |
| 14.4 | kV | 240 | 2% | 244.8 | 5% | 232.6 | 257.0 | 8.0% | 251.2 | 277.6 |
| 34.5 | kV | 416 | 5% | 436.8 | 5% | 415.0 | 458.6 | 5.0% | 435.7 | 481.6 |
| 34.5 | kV | 240 | 5% | 252.0 | 5% | 239.4 | 264.6 | 5.0% | 251.4 | 277.8 |
| 480 | V | 433 | −5% | 411.4 | 1% | 407.2 | 415.5 | 7.5% | 437.8 | 446.6 |
| 480 | V | 250 | −5% | 237.5 | 1% | 235.1 | 239.9 | 7.5% | 252.8 | 257.9 |
| 600 | V | 433 | −2% | 424.3 | 1% | 420.1 | 428.6 | 5.0% | 441.1 | 450.0 |
| 600 | V | 250 | −2% | 245.0 | 1% | 242.6 | 247.5 | 5.0% | 254.7 | 259.8 |
| 4.16 | kV | 433 | 0% | 433.0 | 1% | 428.7 | 437.3 | 2.5% | 439.4 | 448.3 |
| 4.16 | kV | 250 | 0% | 250.0 | 1% | 247.5 | 252.5 | 2.5% | 253.7 | 258.8 |
| 7.2 | kV | 433 | 2% | 441.7 | 1% | 437.2 | 446.1 | 0.0% | 437.2 | 446.1 |
| 7.2 | kV | 250 | 2% | 255.0 | 1% | 252.5 | 257.6 | 0.0% | 252.5 | 257.6 |
| 12.47 | kV | 433 | 5% | 454.7 | 1% | 450.1 | 459.2 | −2.5% | 438.9 | 447.7 |
| 12.47 | kV | 250 | 5% | 262.5 | 1% | 259.9 | 265.1 | −2.5% | 253.4 | 258.5 |
| 13.2 | kV | 433 | −5% | 411.4 | 3% | 399.0 | 423.7 | 8.5% | 432.9 | 459.7 |
| 13.2 | kV | 250 | −5% | 237.5 | 3% | 230.4 | 244.6 | 8.5% | 250.0 | 265.4 |
| 14.4 | kV | 433 | −2% | 424.3 | 3% | 411.6 | 437.1 | 5.0% | 432.2 | 458.9 |
| 14.4 | kV | 250 | −2% | 245.0 | 3% | 237.7 | 252.4 | 5.0% | 249.5 | 265.0 |
| 23.9 | kV | 433 | 0% | 433.0 | 3% | 420.0 | 446.0 | 3.0% | 432.6 | 459.4 |
| 23.9 | kV | 250 | 0% | 250.0 | 3% | 242.5 | 257.5 | 3.0% | 249.8 | 265.2 |
| 34.5 | kV | 433 | 2% | 441.7 | 3% | 428.4 | 454.9 | 1.0% | 432.7 | 459.5 |
| 34.5 | kV | 250 | 2% | 255.0 | 3% | 247.4 | 262.7 | 1.0% | 249.8 | 265.3 |
| 69 | kV | 433 | 5% | 454.7 | 3% | 441.0 | 468.3 | −2.0% | 432.2 | 458.9 |
| 69 | kV | 250 | 5% | 262.5 | 3% | 254.6 | 270.4 | −2.0% | 249.5 | 265.0 |
| 480 | V | 433 | −5% | 411.4 | 5% | 390.8 | 431.9 | 10.0% | 429.9 | 475.1 |
| 480 | V | 250 | −5% | 237.5 | 5% | 225.6 | 249.4 | 10.0% | 248.2 | 274.3 |
| 600 | V | 433 | −2% | 424.3 | 5% | 403.1 | 445.6 | 7.0% | 431.3 | 476.7 |
| 600 | V | 250 | −2% | 245.0 | 5% | 232.8 | 257.3 | 7.0% | 249.0 | 275.3 |
| 7.2 | kV | 433 | 0% | 433.0 | 5% | 411.4 | 454.7 | 5.0% | 431.9 | 477.4 |
| 7.2 | kV | 250 | 0% | 250.0 | 5% | 237.5 | 262.5 | 5.0% | 249.4 | 275.6 |
| 14.4 | kV | 433 | 2% | 441.7 | 5% | 419.6 | 463.7 | 3.0% | 432.2 | 477.7 |
| 14.4 | kV | 250 | 2% | 255.0 | 5% | 242.3 | 267.8 | 3.0% | 249.5 | 275.8 |
| 34.5 | kV | 433 | 5% | 454.7 | 5% | 431.9 | 477.4 | 0.0% | 431.9 | 477.4 |
| 34.5 | kV | 250 | 5% | 262.5 | 5% | 249.4 | 275.6 | 0.0% | 249.4 | 275.6 |

7. The system of claim 1, further comprising a tap-switch between the transformer taps and the distribution panel on at least one of the multi-phase lines, the tap-switch being configured to be operated while power is being received.

8. The system of claim 1, further comprising a voltage regulator between the transformer taps and the distribution panel on at least one of the multi-phase lines.

9. The system of claim 8, further comprising an uninterruptible-power-supply (UPS) module between the transformer taps and the distribution panel on at least one of the multi-phase lines.

10. The system of claim 9, further comprising a control system configured to:
monitor an actual voltage for a corresponding nominal transformer output on the at least one of the multi-phase lines; and
operate, considering the capacities of the voltage regulator, the tap-switch for voltage-stabilization thereof, the UPS preventing a gap during operation of the tap-switch between transformers taps.

11. The system of claim 1, wherein the plurality of electrical components further comprises an external-power-source-input component for receiving power from one or more alternate power generation unit, the external-power-source-input component providing power received therefrom to the multi-phase transformer.

12. The system of claim 1, further comprising a cancelling harmonic filter connected to either the distribution panel or cabinet.

13. A skid for supporting a plurality of electrical components, the skid comprising:
a plurality of openings defining:
a first position configured to receive a cabinet;
a second position configured to receive a power manipulation component; and
a third position configured to receive a distribution panel;
pre-positioned mechanical elements configured to structurally integrate two or more additional skids thereto, the additional skids when integrated providing at least a fourth position configured to receive one of the plurality of electrical components; and
a walk-way of at least 3 feet of width having one or more detachably attachable floor panels;
wherein the first position and the third position are positioned back-to-back and fit within 6 feet when the cabinet and the distribution panel are installed;
wherein the skid is no more than 11.5 feet wide, 40 feet long and 12.5 feet high in order to fit within an expected parking lot spot.

14. The skid of claim 13 further comprising a longitudinal section, the plurality of openings being positioned therein, the longitudinal section being no more than 8 feet 6 inches.

15. The skid of claim 13, wherein the walk-way extends on all of the longitudinal length of the skid.

16. The skid of claim 13, wherein the floor panels provide anti-slippery walking surfaces.

17. The skid of claim 13 further comprising inner lifting points positioned considering expected mechanical loads of the plurality of electrical components.
